(19) United States
(12) Patent Application Publication
(10) Pub. No.: US 2026/0356636 A1
(43) Pub. Date: Nov. 12, 2026

(54) METHOD AND DEVICE FOR MONITORING THE DRIVE OPERATION OF A PASSENGER CONVEYOR SYSTEM

(71) Applicant: Inventio AG, Hergiswil (CH)

(72) Inventors: Patrick Zhang, Shanghai (CN); Gerhard Stoiber, Zistersdorf (AT)

(21) Appl. No.: 18/704,401

(22) PCT Filed: Nov. 22, 2022
(86) PCT No.: PCT/EP2022/082877

§ 371 Date: Apr. 24, 2024

(30) Foreign Application Priority Data
Dec. 17, 2021 (EP) 21215358.9

(51) Int. Cl. B66B 29/00

(52) U.S. Cl. CPC B66B 29/005

(57) ABSTRACT

The disclosure relates to a monitoring system and a method for monitoring person-transporting installations. The monitoring system has at least one hazard analysis module, an interaction module, a control module, at least one motion-sensing module, and a speed controller to be actuated manually, which are connected to one another via a data network. As soon as the hazard analysis module detects a critical situation, the control module connects the speed controller to the person-transporting installation at which the critical situation has occurred. The monitoring personnel can influence the driving speed of this passenger convey or system by manually actuating the speed controller.

The invention relates to a method for monitoring the travel operation of one or more person-transporting installations, and to a device for carrying out this method.

Person-transporting installations such as escalators and moving walkways are used, for example, in department stores and large shopping centers, but also in train stations, subway stations, and airports. In the three last-mentioned settings, there can be an increased risk of accidents during peak times if time-pressed users jostle other users on the person-transporting installations. This means that jostled persons can fall on the escalator transport belt or step belt or on the moving walkway plate belt and sustain serious injuries if the step belt or plate belt is not stopped by means of an emergency stop. Others recklessly misuse person-transporting installations as sports and play equipment, putting themselves and other users in danger. Video cameras are often used to monitor these person-transporting installations. Such monitoring systems with video cameras are disclosed, for example, in documents JP 5 917327B2, JP 2009 120327 A, EP 1 013 599 A1, JP 2010 070299 A, and KR 102 215 565B1.

If a building has a plurality of escalators and/or moving walkways, in many cases the video sequences are transmitted in real time to a monitoring room where they are displayed on screens. From the monitoring room, a group of person-transporting installations is supervised by a single monitoring operator. In addition, the monitoring operator often monitors and operates the lighting, the fire alarm, the ventilation, and, if necessary, other facilities such as security gates and the like in the region of their assigned group of person-transporting installations.

The high density of monitoring activities can lead to rapid fatigue and reduced attention of the monitoring operator. If a critical situation occurs on one of the person-transporting installations, reduced attention can worsen the critical situation and, in severe cases, lead to serious injuries or, in the worst case, death of the affected user.

In order to solve the above problem, monitoring rooms are set up in such a way that critical situations for users on the person-transporting installation can be automatically recognized by processing motion sequence images by means of image recognition. As soon as a critical situation is recognized, the corresponding motion sequence image is displayed on the monitoring room screen. The motion sequence image is provided with an identification number so that the monitoring operator can immediately identify on which person-transporting installation in their group a critical situation has occurred.

Below the screen, a number of physical emergency-stop switches are arranged corresponding to the number of monitored person-transporting installations, wherein each emergency-stop switch is connected to the safety circuit of the corresponding person-transporting installation. As soon as a critical situation occurs, the monitoring personnel must find the associated emergency-stop switch of the person-transporting installation shown in the motion sequence image with its identification number and activate it.

This search can greatly reduce the emergency response speed, so that the intervention of the monitoring personnel comes too late. Additionally, in the case of dramatic scenes in the motion sequence image, the monitoring room personnel may panic and press the wrong emergency-stop switch, resulting in an emergency stop of another person-transporting installation that should not stop. This does not defuse the critical situation and causes inconvenience to the users of the mistakenly stopped person-transporting installation, because a stopped installation cannot be put back into operation immediately. In the event of an abrupt stop, such as the emergency stop defined in standards (e.g., EN-115), users not affected by the critical situation may even fall and injure themselves. Situations can therefore arise in which initiating an emergency stop does more harm than good to users.

In order to solve the problems described above, the object of the present invention is to provide a monitoring system for a person-transporting installation realized as an escalator or moving walkway which allows the monitoring room personnel to react immediately and adequately to a critical situation in order to prevent this critical situation from worsening.

This object is achieved by a method for monitoring the travel operation of a person-transporting installation designed as an escalator or moving walkway by means of a monitoring system. The monitoring system has a hazard analysis module, an interaction module, a control module, and at least one motion-sensing module. The motion-sensing module is directed towards an associated person-transporting installation and can capture electronically processable motion sequence images of situations that occur on the associated person-transporting installation.

In other words, a motion-sensing module or a plurality of motion-sensing modules are directed towards an associated person-transporting installation and continuously record the processes or situations currently occurring on the escalator or moving walkway. Video cameras, thermal imaging cameras, laser scanners, TOF cameras, a set of multiple sensors and the like can be used as motion-sensing modules, the motion sequence images of which are accordingly captured as a video film sequence, image sequence, thermal image sequence, etc., in an electronically processable form. When multiple motion-sensing modules per person-transporting installation are used, each motion-sensing module is preferably associated with a specific section or region, so that the entire escalator or the entire moving walkway is not visible in any of the motion sequence images.

According to the invention, the motion sequence images are transmitted to the hazard analysis module in real time. In the hazard analysis module, the motion sequence images are examined for critical situations using analysis algorithms. In other words, automated recognition processes or analysis methods known from the technical field of surveillance electronics, such as image analysis methods and corresponding algorithms, motion analysis methods and corresponding algorithms, statistical and heuristic evaluation methods and the like, are used more for recognizing user movements that deviate from usual movements or are atypical movements. Depending on the motion sequence of a deviating motion process, the hazard analysis module can assume a critical situation. A possible embodiment of this automated assessment process is described in more detail below.

As soon as a critical situation is detected, the hazard analysis module sends a warning signal to the interaction module, the warning signal including at least one identification number of the motion-sensing module in whose motion sequence image the critical situation was detected. The interaction module serves for interaction with the monitoring personnel and has at least one screen on which the motion sequence images can be displayed or visually represented. Based upon the warning signal, the motion sequence image correlating with the identification number is displayed on a screen of the interaction module.

As a result of the warning signal, the interaction module also sends to the control module a person-transporting installation identification number of the person-transporting installation which is associated with the corresponding identification number of the motion-sensing module.

Based upon the person-transporting installation identification number, the control module temporarily establishes a signal connection between a manually actuated speed controller of the interaction module and a controller of the corresponding person-transporting installation. By actuating the speed controller, the travel operation of this person-transporting installation can be controlled manually. The speed of the person-transporting installation depends upon the manually adjusted setting of the speed controller.

In the present document, “temporary” means that the signal connection is not established permanently due to the warning signal, but is initiated by the warning signal. The cancellation of the established temporary signal connection can take place, for example, based upon feedback from the above-mentioned control module that the influencing of the travel operation of the person-transporting installation specified by the speed controller has been implemented. However, the cancellation can also take place on the basis of a further warning signal, in which case a test routine is required.

The test routine checks various parameters such as the actuating movement of the speed controller (whether accelerating or decelerating) or the weighting of the critical situation (described in more detail below) and refuses to disconnect the signal connection or instructs the controller of the corresponding person-transporting installation to automatically control the travel operation after disconnection, so that, for example, a current transporting speed is maintained, acceleration is made to nominal speed, or braking to a standstill is carried out.

In one embodiment of the invention, during travel operation of the person-transporting installation, a transporting speed can be controlled proportionally to the position of the speed controller. This has the advantage that the monitoring personnel can carry out the measure to be taken, i.e., deceleration or acceleration of the transporting speed, “by feel” and can react even more adequately to the situation.

In a further embodiment of the invention, a reduction in the transporting speed down to a predetermined deceleration limit value can be controlled manually. This can prevent the escalator or moving walkway from being stopped too abruptly due to panicked reactions, for example, which could cause users to fall and damage the mechanical components of the person-transporting installation. In addition, the standard specifications defined in EN-115, for example, can thereby be correctly implemented.

In a further embodiment of the invention, an increase in the transporting speed up to a prespecified acceleration limit can be controlled manually. This prevents excessive acceleration from causing users standing on the escalator or moving walkway to fall.

In a further embodiment of the invention, the reduction in the transporting speed can follow a stored deceleration profile, or the increase in the transporting speed can follow a stored acceleration profile. A direct implementation of a change in the position of the speed controller is thereby overridden. In other words, while the monitoring personnel can select the transporting speed by means of the corresponding position of the speed controller, the manual actuation speed of the speed controller is not reflected proportionally in the change in deceleration or acceleration of the transporting speed.

In a further embodiment of the invention, a manually operated emergency stop triggering device is present parallel to the speed controller. On the basis of the received person-transporting installation identification number, the control module establishes a signal connection between the emergency stop triggering device and the controller of the associated person-transporting installation. When the emergency stop triggering device is actuated manually, the travel operation of the person-transporting installation connected to the emergency stop triggering device is immediately stopped. The monitoring personnel can optionally select whether they wish to actuate the speed controller or the emergency stop triggering device.

As already mentioned above, an automated recognition process and assessment process of critical situations takes place in the hazard analysis module, wherein the deviating motion sequences recognized by known analysis methods are extracted from the motion sequence images and then assessed. In order to carry out the assessment process, a set of possible critical situations can be stored in the hazard analysis module. This set comprises various atypical motion scenarios that can be compared with the motion sequences extracted from the motion sequence images. This set of atypical motion scenarios can be generated, for example, through a machine learning process by using a dummy or stuntman to recreate and record typical critical situations such as falls or careless actions on the person-transporting installation and to include the extracted motion sequences in the set as atypical motion scenarios. Of course, it is also possible to create such motion scenarios purely virtually with suitable software and sufficient computing power. Of course, the set can also be supplemented with further atypical motion scenarios which, during operation of the person-transporting installation, had led to an accident and were not recognized by the hazard analysis module. In the event of sufficient correspondence between an extracted motion sequence and an atypical motion scenario, the hazard analysis module assumes the existence of a critical situation and sends a warning signal to the interaction module.

The various atypical motion scenarios in the set preferably have different weightings in the sense of a ranking. According to these weightings, different actions for influencing the travel operation can be defined. For example, the control module can enable the connection between the manually actuated emergency stop triggering device and the controller of the corresponding person-transporting installation for actuation only when a detected fall of a user has a very high weighting, and an emergency stop is defined as the action for this high weighting. The emergency stop is initiated immediately when the monitoring personnel actuate the emergency stop triggering device.

If, for example, a user enters the person-transporting installation counter to its transporting direction, this critical situation can have a medium weighting, and, for this medium weighting, it can be provided that the control module enable only the connection between the speed controller to be manually actuated and the control of the corresponding person-transporting installation for actuation.

It is also possible for a user to resolve the critical situation themselves—for example, by catching their fall by holding on to the handrail and then standing up again. Based upon the detected situation, this motion sequence image is immediately displayed on the screen of the interaction module so that the monitoring personnel are made aware of it and can if necessary remedy the causes of the near fall (user distraction, disturbing influences outside the escalator or moving walkway). However, the low weighting has the effect that the control module does not enable any of the aforementioned connections. It should also be noted here that the establishment of a connection does not automatically mean that it is enabled.

So that the monitoring staff knows whether the emergency stop triggering device or the speed controller is enabled, corresponding instructions can be displayed on the screen of the interaction module, and/or acoustic instructions can be outputted via a loudspeaker of the interaction module.

In one embodiment of the invention, the monitoring system can have a plurality of motion-sensing modules that capture motion sequence images from at least two different person-transporting installations. Each of the motion-sensing modules has an identification number and provides its motion sequence images with this identification number, or encodes its motion sequence images accordingly. As soon as the hazard analysis module has recognized a critical situation in a motion sequence image, it provides the warning signal to be outputted with the same identification number that the corresponding motion sequence image with the critical situation has. In the interaction module, the identification numbers of the motion-sensing modules are unambiguously assigned to the person-transporting installation identification numbers-for example, via a table stored in the interaction module.

In a further embodiment of the invention and when weighting is implemented, the hazard analysis module can send warning signals with the associated weighting to the interaction module in immediate succession when a plurality of critical situations are recognized simultaneously, wherein the motion sequence images are emphasized visually and/or acoustically in succession on the basis of their weighting. In other words, the motion sequence image with the most critical situation is emphasized first. As soon as the monitoring personnel have tapped the confirmation input field, the motion sequence image with the second most critical situation is emphasized, etc.

As mentioned above, users can often save themselves from critical situations by, for example, just holding on to the handrail when falling and thereby resolving the critical situation themselves. In such cases, the hazard analysis module may have already recognized the user's motion sequences as a critical situation before the user has saved himself/herself. In order to take these circumstances into account, in a further embodiment of the invention, the interaction module can also generate a cancellation input field as a result of the warning signal on the screen. By means of manual tapping of the cancellation input field, the interaction module can be prompted to cancel the warning signal and to withdraw the associated display of the corresponding motion sequence image. By actuating the cancellation input field, no forwarding of the associated person-transporting installation identification number to the control module takes place, and thus the travel operation of the affected person-transporting installation is also not capable of being influenced.

If there are concerns that the monitoring operator could press the cancellation input field when in a hurry despite the visual distinction, these concerns can be remedied with one development. This development provides that, immediately after tapping the cancellation input field, the associated motion sequence image be analyzed for a prespecified time—preferably in the hazard analysis module. In other words, this motion sequence image is further examined for critical situations for a prespecified time. If the monitoring operator mistakenly taps the cancellation input field, the same motion sequence image, along with the cancellation input field, immediately “pops” back up, and the monitoring operator can make his/her selection again as to how the monitoring system should respond.

In a further embodiment, in the event of a warning signal, the interaction module can output an acoustic and/or visual warning to the users of the person-transporting installation via an output module. The output module is arranged in the region of the person-transporting installation which is associated with the warning signal. In other words, each person-transporting installation is associated with at least one output module which is operated depending upon the identification number of the warning signal. This is preferably directed at the person-transporting installation in such a way that the acoustic warning addresses only the users of this person-transporting installation or individual users, and not the entire surrounding area. The output module can be a loudspeaker, a loudspeaker system, a screen display, a projector for two-dimensional representations or holograms and the like. A combination of acoustically and visually output warnings is most effective. The warnings to be output can be tailored to the corresponding critical situation and its resolution, so that, if an emergency stop is initiated, the other users are warned before it is initiated. Preferably, a set of different warnings is available, from which a warning adequate for the critical situation is automatically selected, e.g., on the basis of the weighting described above, and output via the output module.

The methods described above can be carried out using a monitoring system. As already mentioned, the monitoring system has at least one hazard analysis module, an interaction module, a control module, at least one motion-sensing module, and a speed controller to be actuated manually, which are connected to one another via a data network. The data network can here include wired and wireless connection units such as CAN bus systems, LAN and WLAN networks, Bluetooth connections, Internet connections, cloud systems, and the like, which are suitable for exchanging data between the aforementioned modules and the person-transporting installation connected to the monitoring system and, if necessary, processing it, e.g., in cloud solutions in which one or more modules are implemented in a cloud (data cloud).

As already mentioned, the monitoring system comprises an interaction module with a speed controller. So that the monitoring personnel can manually actuate the speed controller, it has a controller actuator-for example, a rotary knob or a pivotable lever. Since, as explained above, motion sequence images with critical situations can be displayed one after the other, and adequate reactions can be carried out by the monitoring personnel, the situation can arise that, during a change, the position of the controller actuator does not correspond to the current travel speed. The speed controller therefore preferably has a reset mechanism. Immediately after the establishment of a connection between the controller and the speed controller, this reset mechanism brings the controller actuator into a position which represents the current travel speed of the person-transporting installation connected to the speed controller. The reset mechanism also performs the same function when the connection is changed to another person-transporting installation by the control module.

Embodiments of the invention will be described below with reference to the accompanying drawings, wherein neither the drawings nor the description are intended to be interpreted as limiting the invention. Identical or equivalent features have the same reference signs. In the drawings:

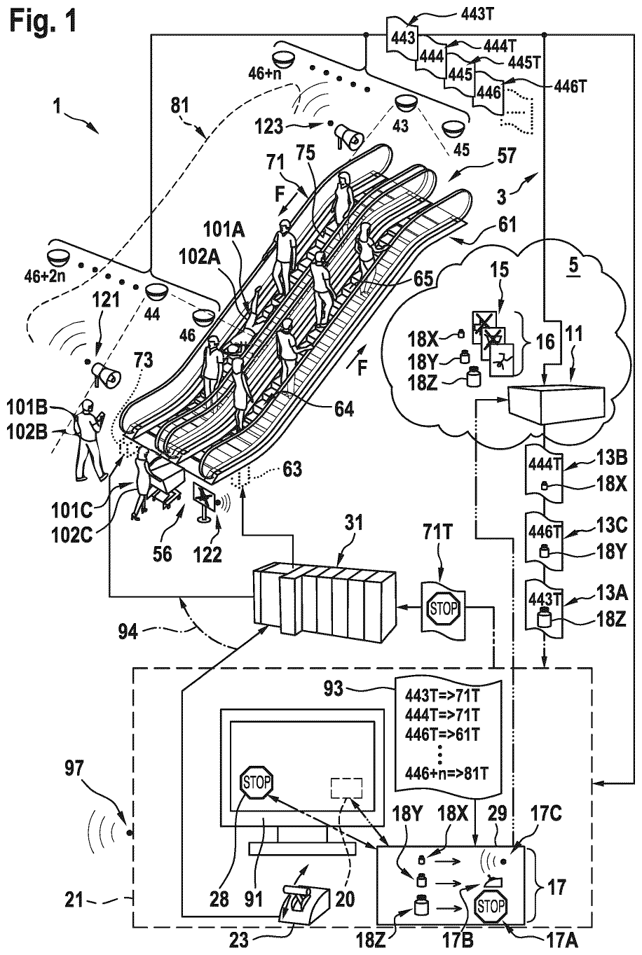

FIG. 1 is a three-dimensional view of a plurality of person-transporting installations, the travel operation of which is to be monitored, and a monitoring system with a speed controller for monitoring these person-transporting installations;

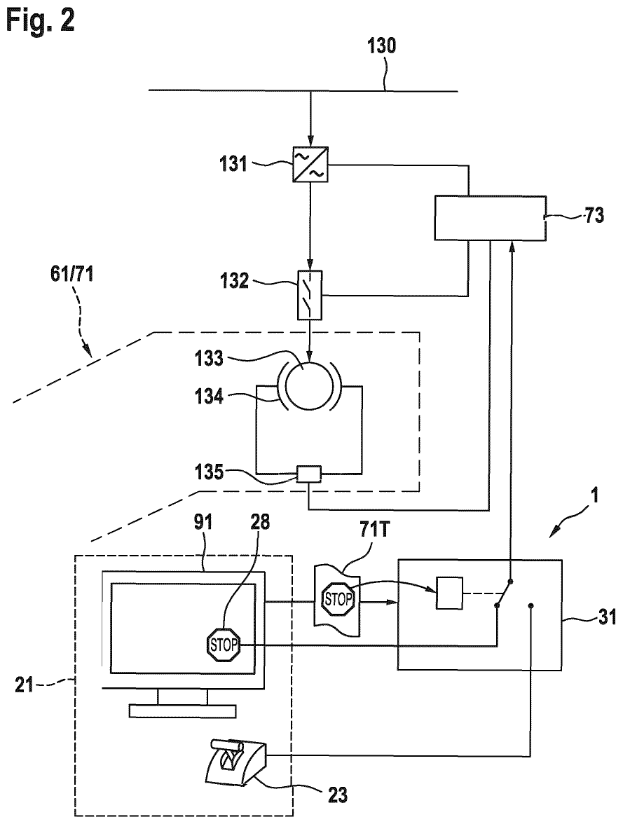

FIG. 2 schematically shows the processes in the interaction module of the monitoring system from FIG. 1 when an emergency stop triggering device is additionally present, as well as signal flows and interactions between one of the person-transporting installations shown in FIG. 1 and the control module;

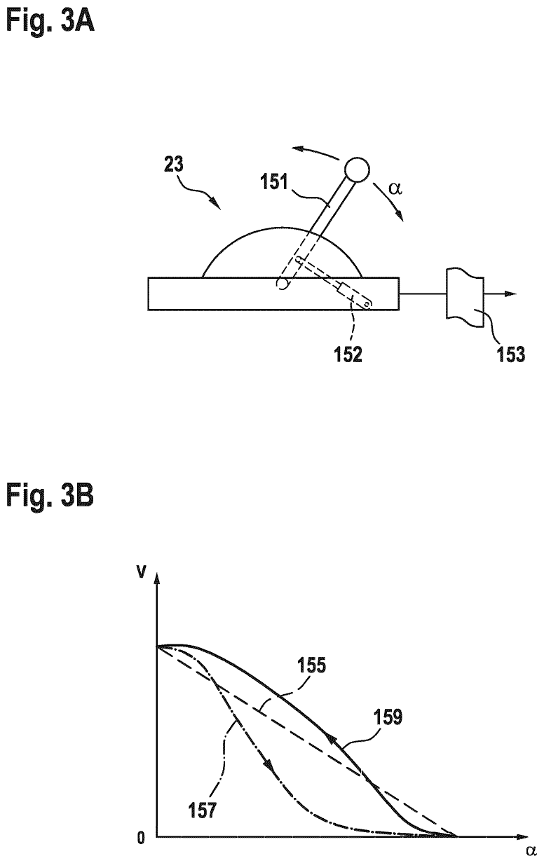

FIG. 3A shows the speed controller shown in FIG. 1 in side view;

FIG. 3B is a diagram representing the speed control of the speed controller from FIG. 2A; and

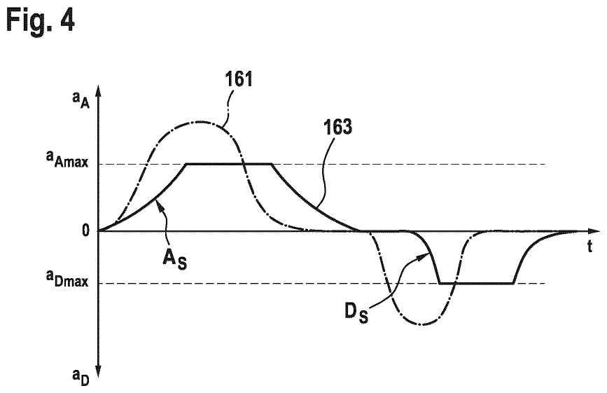

FIG. 4 is a diagram representing acceleration and deceleration limits when using the speed controller shown in FIGS. 1 and 3.

FIG. 1 shows a three-dimensional view of a plurality of person-transporting installations 61, 71, 81, the travel operation F of which is monitored by means of a monitoring system 1. The monitoring system 1 has for this purpose a hazard analysis module 11, an interaction module 21, a control module 31, and a speed controller 23 to be actuated manually. The speed controller 23 is here a component of the interaction module 21.

In order to be able to monitor a plurality of person-transporting installations 61, 71, 81, the monitoring system 1 additionally has a plurality of motion-sensing modules 43, 44, 45, 46, 46+n, 46+2n. In the present embodiment, two person-transporting installations 61, 71 designed as escalators are shown in detail. The balustrade outlined with a broken line symbolizes a plurality of additional person-transporting installations 81. Each of these person-transporting installations 61, 71, 81 is associated with two motion-sensing modules 43, 44, 45, 46, 46+n, 46+2n, which capture motion sequence images 443, 444, 445, 446, . . . from the travel operation F of “their” person-transporting installations 61, 71, 81. Each of the motion-sensing modules 43, 44, 45, 46, 46+n, 46+2n has an identification number 443T, 444T, 445T, 446T, . . . and encodes its motion sequence images 443, 444, 445, 446, . . . accordingly.

The aforementioned modules 11, 21, 31, 43, . . . , 46+2n are connected to one another via a data network 3. The design of the data network 3 is not shown in detail, since this can be set up in a variety of ways, such as via a local wired and/or wireless data network 3, via internet connections in a cloud 5, via CAN bus systems, Bluetooth connections, and the like. Relevant to the invention is only that the individual modules 11, 21, 31, 43, . . . , 46+2n can exchange data with one another, wherein this data exchange between the individual modules 11, 21, 31, 43, . . . , 46+2n can take place unidirectionally or bidirectionally, as well as permanently, sequentially, or temporarily, as required. The most important connections of the data network 3 are symbolically represented by means of arrows. It should also be mentioned that the hazard analysis module 11, and optionally also a computing unit 29 of the interaction module 21 and/or the control module 31 and its data memory, can be implemented in the cloud 5.

Different methods for monitoring the travel operation F of a person-transporting installation 61, 71, 81 can be carried out by means of the monitoring system 1. Of course, the monitoring system 1 shown could also be used to monitor only a single person-transporting installation 61, 71, 81. Each of the motion-sensing modules 43, . . . , 46+2n is directed towards an associated person-transporting installation 61, 71, 81 and detects electronically processable motion sequence images 443, . . . , 446+2n of situations 101A, 101B, 101C that occur on the associated person-transporting installation 61, 71, 81. This can also include the immediate vicinity of the person-transporting installation 61, 71, 81.

The immediate vicinity includes, for example, the regions of the structure (not shown) upstream of the access regions 56, 57 in which the person-transporting installation 61, 71, 81 is installed. The upstream regions of the structure are also referred to as vestibules and may be monitored by proximity sensors (not shown) of the person-transporting installation 61, 71, 81. The proximity sensors transmit their detection data to an “automatic start/stop system” of the person-transporting installation 61, 71, 81, which is usually implemented in its controller 63, 73.

Video cameras, thermal imaging cameras, laser scanners, TOF cameras, a combination of multiple sensors, and the like can be used as motion-sensing modules 43, . . . , 46+2n, wherein the motion sequence images 443, 446 thereof are accordingly captured as a video film sequence, image sequence, thermal image sequence, etc., in an electronically processable form. When multiple motion-sensing modules 43, . . . , 46+2n are used per person-transporting installation 61, 71, 81, each motion-sensing module 43, . . . , 46+2n will be associated with a specific section or region. These regions preferably overlap, so that there are no monitoring gaps in which critical situations 101A, 101B, 101C for users 102A, 102B, 102C can occur unobserved. Possible critical situations 101A, 101B, 101C are described in more detail below with reference to three examples. Since monitoring should be as reliable as possible, the motion-sensing modules 43, . . . , 46+2n preferably continuously record what is happening on the person-transporting installations 61, 71, 81. This also includes the motion-sensing modules 43, . . . , 46+2n transmitting their motion sequence images 443, . . . , 446+2n to the hazard analysis module 11 in real time. The transmitted motion sequence images 443, . . . , 446+2n are analyzed for critical situations 101A, . . . , 101C in the hazard analysis module 11 using analysis algorithms. These analysis algorithms are based, for example, upon known image processing techniques that are optimized and applied in self-learning processes using artificial intelligence in neural networks. A common image processing technique for generating information from an image is, for example, the calculation of the histogram which provides information about the statistical brightness distribution in the image. Such a histogram can serve, for example, as a configuration for further image processing steps or as information for a human user of software. Other computable information about an image is, for example, its entropy or average brightness. Based upon this information, vector analyses can follow how individual prominent points move relative to one another, and conclusions can be drawn from this about motion scenarios of users 102A, 102B, 102C. Of course, instead of the method steps described above, other analysis techniques and analysis methods known from the technical field of video surveillance can also be used to extract motion sequences of the users 101A, 101B, 101C from the motion sequence images 443, . . . , 446+2n.

As soon as a motion sequence of a user 102 102A, 102B, 102C has been recognized by the hazard analysis module 11 and extracted, for example, as a skeletal motion sequence, the motion sequence can be compared with a stored set 16 of possible critical situations. More precisely, the critical situations stored in the set 16 reflect atypical motion scenarios 15 in possible critical situations. As soon as the hazard analysis module 11 has detected a critical situation 101A, . . . , 101C, it sends a warning signal 13A, . . . , 13C to the interaction module 21. The warning signal 13A, . . . , 13C has at least one identification number 443T, . . . , 446T of the motion-sensing module 43, . . . , 46+2n in whose motion sequence image 443, . . . , 446+2n the critical situation 101A, . . . , 101C was detected.

Based upon the warning signal 13, . . . , 13C, the motion sequence image 443, . . . , 446+2n correlating with the identification number 443T, . . . , 446T, is displayed on a screen 91 of the interaction module 21. In addition, the interaction module 21 sends to the control module 31 a person-transporting installation identification number 61T, 71T, 81T of the person-transporting installation 61, 71, 81 which is associated with the corresponding identification number 443T, . . . , 446T of the motion-sensing module 43, . . . , 46+2n. The assignments of the identification number 443T, . . . , 446T to the person-transporting installation identification numbers 61T, 71T, 81T are stored, for example, as a relationship table 93 in a storage medium (not shown) of the computing unit 29 of the interaction module 21.

Since a critical situation 101A, 101B, 101C is usually a dynamic event, it is entirely possible that, for the example of the escalator 71, it is recorded first in the motion sequence image 443 of the motion-sensing module 43 arranged at the upper right in relation to the viewing plane and then in the motion sequence image 444 of the motion-sensing module 44 arranged at the lower left. Since both motion sequence images 443, 444 are analyzed simultaneously by the hazard analysis module 11, corresponding warning signals 13A which have different identification numbers 443T, 444T are sent successively to the interaction module 21. A logic is implemented in the computing unit 29 of the interaction module 21, which logic automatically changes the motion sequence image 443, 444 displayed on the screen 91 according to the temporal order of the warning signals 13A.

After receiving a person-transporting installation identification number 61T, 71T, 81T, the control module 31 establishes a temporary signal connection 94 (symbolically represented by a dot-dashed double arrow) between a manually actuated speed controller 23 of the interaction module 21 and a controller 63, 73 of the corresponding person-transporting installation 61, 71, 81. By actuating the speed regulator 23, the travel operation F of this person-transporting installation 61, 71, 81 is controlled manually. For better understanding of the present invention, three critical situations 101A to 101C are shown by way of example on the person-transporting installations 61, 71 shown in FIG. 1 and in the immediate vicinities thereof. A set 16 of possible critical situations 15 is present in the hazard analysis module 11, matching these critical situations 101A, 101B, 101C. As already mentioned above, the set 16 comprises various atypical motion scenarios 15 with which motion sequences extracted from the motion sequence images 443, . . . , 446+2n are compared. The possible location at which such a critical situation 101A, 101B, 101C can take place may also play a role. An atypical motion scenario 15, which represents a fall in the inclined central section of an escalator, cannot occur in the same way in the entrance of the person-transporting installation 61, 71, 81 or in one of the access regions 56, 57. The set 16 of atypical motion scenarios 15 can be generated, for example, through a machine learning process by using a dummy or stuntman to recreate typical critical situations 101A, 101B, 101C such as falls or careless actions on the person-transporting installation 61, 71, 81. The motion sequences detected and extracted here can be included in the set 16 as atypical motion scenarios 15. Of course, the set 16 can also be supplemented with additional atypical motion scenarios 15 which, during operation of the person-transporting installation 61, 71, 81, had led to an accident and which were not recognized by the hazard analysis module 11. In the event of sufficient correspondence between an extracted motion sequence and an atypical motion scenario 15, the hazard analysis module 11 can assume or determine the existence of a critical situation and send a warning signal 13A, 13B, 13C to the interaction module 21.

As symbolically represented by weights 18X, 18Y, 18Z of different sizes, the various atypical motion scenarios 15 of the set 16 have different weightings 18X, 18Y, 18Z in the sense of a ranking. The critical situation 101A recorded by the motion-sensing module 43 is recognized in the hazard analysis module 11 as a “fall,” and the associated warning signal 13A is provided with the highest weighting 18Z, since continued travel operation F could lead to serious injuries to the user 102A who has fallen.

The critical situation 101B recorded by the motion-sensing module 44 is recognized in the hazard analysis module 11 as “entering in the wrong direction,” and the associated warning signal 13B is provided with the lowest weighting 18X. By entering incorrectly, the user 102B does not put himself/herself in immediate danger, but, rather, disturbs the oncoming users when leaving the person-transporting installation 71.

The critical situation 101C recorded by the motion-sensing module 46 is recognized in the hazard analysis module 11 as “entering with a shopping cart,” and the associated warning signal 13C is provided with a medium weighting 18Y. The user 102C is only in danger when he/she reaches the ascending central section of the person-transporting installation 61 with his/her shopping cart.

As shown, the monitoring system 1 can additionally have an emergency stop triggering device 28. In the present exemplary embodiment, such an emergency stop triggering device 28 is implemented in the operating software of the interaction module 21. FIG. 2 schematically shows the processes in the interaction module 21 of the monitoring system 1 from FIG. 1 when an emergency stop triggering device 28 is additionally present. By way of example, signal flows and interactions between the person-transporting installation 71 shown in FIG. 1 and the control module 31 are also shown in FIG. 2. FIG. 1 and FIG. 2 are described together below.

If a manually actuated emergency stop triggering device 28 is present parallel to the speed controller 23, the control module 31 can establish a connection between the emergency stop trigger device 28 and the controller 73 of the associated person-transporting installation 71 based upon a received person-transporting installation identification number 71T. In the present embodiment, the software of the interaction module 21 generates a button on the touch screen of the display 91 upon receiving the person-transporting installation identification number 71T. When there is a manual actuation of the emergency stop triggering device 28 or the button is tapped, the travel operation F of the person-transporting installation 71 connected to the emergency stop triggering device 28 is immediately stopped.

In principle, it is possible for the control module 31 to simultaneously connect both the emergency stop triggering device 28 and the speed controller 23 to the controller 73 of the corresponding person-transporting installation 71. In the event of simultaneous actuation of the emergency stop triggering device 28 and the speed regulator 23, priority is given to the signal of the emergency stop triggering device 28.

However, the travel operation F is preferably influenced by means of the weighting 18X, 18Y, 18Z. For example, the control module 31 can enable only the signal connection between the manually actuated emergency stop triggering device 28 and the controller 73 of the corresponding person-transporting installation 71. However, the control module 31 can also enable only the signal connection between the manually actuated speed controller 23 and the controller 73 of the corresponding person-transporting installation 71. It is also possible for the control module 31 to not enable any of the aforementioned connections based upon the weighting 18X, 18Y, 18Z.

The function of the weighting 18X, 18Y, 18Z with regard to releasing the signal connection is described in more detail below with reference to the critical situations 101A, 101B, 101C already described. For this purpose, connection instructions 17 are stored in the computer unit 29 of the interaction module 21. The connection instructions 17 can be retrieved according to the weighting 18X, 18Y, 18Z of the warning signal 13A, 13B, 13C. The signal connection is selected on the basis of the weighting 18X, 18Y, 18Z or the connection instruction 17 assigned to this weighting 18X, 18Y, 18Z. For example, in the critical situation 101A detected by the motion-sensing module 43, the connection instruction 17A is linked to the person-transporting installation identification number 71T, whereby the control module 31 connects the affected person-transporting installation 71 to the emergency stop release device 28 and enables it. When the button of the emergency stop triggering device 28 is tapped, the controller 73 of the affected person-transporting installation 71 immediately initiates an emergency stop, e.g., by the controller 73 electrically braking the drive motor 133 of the person-transporting installation 71 via a frequency converter 131, simultaneously engaging the brake 134 of the person-transporting installation 71 by disconnecting its release solenoid 135, and disconnecting the drive motor 133 from the power supply 130 after the brake 134 has been engaged by opening the motor contactors 132.

In the critical situation 101C detected by the motion-sensing module 46, the connection instruction 17B is linked with the person-transporting installation identification number 61T, whereby the control module 31 connects the controller 63 of the affected person-transporting installation 61 to the speed controller 23 and enables it. If the user in 102C ignores visual or even acoustic warnings (see below), the monitoring personnel can act upon the frequency converter 131 by actuating the speed controller 23 and can carefully reduce the travel speed, even reducing it to zero if necessary. As a result, the users on the transport belt 65 of the person-transporting installation 61 do not experience an abrupt stop, which could cause them to fall. In addition, the user 102C will leave the access area 56 with their shopping cart, as it is impossible for the user to pull the shopping cart over the steps of the stationary transport belt 65. As soon as the user 102C has moved away with the shopping cart, the monitoring personnel can increase the travel speed of the person-transporting installation 61 again by actuating the speed controller 23.

In the critical situation 101B detected by the motion-sensing module 44, the connection instruction 17C is linked to the person-transporting installation identification number 71T, causing the control module 31 to disable the two signal connections described above to the speed controller 23 and to the emergency stop triggering device 28 for the associated person-transporting installation 71. In this case, the monitoring personnel have no possibility of influencing the travel operation F of the affected person-transporting installation 71. As described below, control module 31 can issue predefined warnings to the users as appropriate to the situation—for example, via output modules 121, 122, 123.

It is self-evident that, if two critical situations 101A, 101B occur at the same time on the same person-transporting installation 71, and warning signals 13A, 13B are forwarded to the interaction module 21 in quick succession, the connecting instruction 17 with the higher weighting 18Z will be implemented preferentially by the control module 31.

Since a plurality of person-transporting installations 61, 71, 81 are monitored with the monitoring system 1 in FIGS. 1 and 2, it is entirely possible for a plurality of critical situations 101A, 101B, 101C to occur simultaneously, as shown. In this situation, the hazard analysis module 11 sends warning signals 13A, 13B, 13C with the associated weightings 18X, 18Y, 18Z to the interaction module 21 in immediate succession. The motion sequence images 443, 444, 445, 446, . . . are now shown visually and/or

acoustically emphasized on the central screen 91 in the interaction module 21 based upon their weighting 18X, 18Y, 18Z, so that the monitoring personnel can always assess the most critical situations 101A, 101B, 101C first.

This “succession” can be implemented in different ways. This allows the corresponding motion sequence image 443, 444, 445, 446, . . . to be emphasized for a prespecified period of time before the next motion sequence image 443, 444, 445, 446, . . . is displayed. The change in the next motion sequence image 443, 444, 445, 446, . . . can also take place by operating the speed controller 23, the emergency stop triggering device 28, or the cancellation input field 20 described below.

In the present embodiment of FIG. 1, as a result of the warning signal 13A, 13B, 13C, the interaction module 21 generates a cancellation input field 20 on the screen in addition to the button of the emergency stop triggering device 28. Due to a manual tapping of the cancellation input field 20, the interaction module 21 cancels the warning signal 13A, 13B, 13C and withdraws the associated visual and/or acoustic emphasis of the corresponding motion sequence image 443, 444, 445, 446, . . . or no longer displays it on the screen 91.

So that unintentional or incorrect cancellation cannot lead to serious accidents, immediately after the cancellation input field 20 is tapped, the associated motion sequence image 443, 444, 445, 446, . . . is further analyzed for a prespecified time—preferably in the hazard analysis module 11. Since actuation not only of the button of the emergency stop triggering device 28, but also of the cancellation input field 20 is registered and processed by the computing unit 29, further analysis of the motion sequence image 443, 444, 445, 446, . . . can be initiated by feedback from the computing unit 29 to the hazard analysis module 11, as is symbolically represented by the dash-triple-dotted arrow.

In order to warn users 102A, 102B, 102C of an imminent influence on the travel operation F and/or to draw attention to any incorrect behavior, in the event of a warning signal 13A, 13B, 13C, the control module 31 or the interaction module 21 outputs an acoustic and/or visual warning to the users 102A, 102B, 102C of the person-transporting installation 61, 71, 81 via an output module 121, 122, 123. The output module 121, 122, 123 is arranged in the region of the person-transporting installations 61, 71, 81.

According to the invention, the control module 31 controls those output modules 121, 122, 123, which belong to the person-transporting installation 61, 71, 81 that is associated with the warning signal 13A, 13B, 13C. The visual and/or acoustic warning contains a message correlating with the critical situation 101A, 101B, 101C. This is described in more detail below on the basis of the critical situations 101A, 101B, 101C shown in FIG. 1.

In the case of the critical situation 101A, a “fall” has been recognized by the hazard analysis module 11 and a corresponding warning signal 13A generated. Its identification number 443T causes the interaction module 21 to select the output module 123 closest to the motion-sensing module 43. For example, the acoustic warning, “Attention: emergency stop of the escalator,” selected based upon the weighting 18Z is sent to this output module 123, which is designed as a loudspeaker, via a wireless connection 97.

In the case of the critical situation 101B, an “access in the wrong direction” has been recognized by the hazard analysis module 11 and a corresponding warning signal 13B generated. Its identification number 444T causes the interaction module 21 to select the output module 121 closest to the motion-sensing module 44. For example, the acoustic warning, “Attention: wrong access region,” selected based upon the weighting 18X is sent to this output module 123, which is designed as a loudspeaker, via a wireless connection 97.

In the case of the critical situation 101C, a “prohibited entry with shopping cart” has been recognized by the hazard analysis module 11 and a corresponding warning signal 13C generated. Its identification number 446T causes the interaction module 21 to select the output module 122 closest to the motion-sensing module 46. For example, an image with a crossed-out shopping cart is sent to this output module 122, which is designed as a screen, as a visual warning via a wireless connection 97 and displayed on the screen. Of course, a warning tone can also be output in this case in order to direct attention to the output module 122. In principle, all devices that can output an acoustic and/or visual warning can be used as output modules 121, 122, 123. So-called hologram projectors, by means of which, for example, virtual persons can output warnings to the users 102A, 102B, 102C of the person-transporting installations 61, 71, 81, are particularly effective here.

FIG. 3A shows the speed controller 23 shown in FIG. 1 in side view. This controller comprises a controller actuator 151, the position of which is scanned and converted into a speed value signal 153. The speed value signal 153 is sent, with the corresponding signal connection, to the controller 63, 73 (see also FIGS. 1 and 2) of the relevant person-transporting installation 71, 72, which controller adjusts the transporting speed of the transport belt 65, 75 to this speed specification. As soon as the position of the controller actuator 151 is changed, the controller 63, 73 adjusts the speed of the transport belt 65, 75 in the same way.

In order to illustrate the speed control of the speed controller 23 of FIG. 3A more clearly, FIG. 3B shows a diagram on the abscissa of which a position α (position angle) of the controller actuator 151 is plotted and on the ordinate of which the transporting speed V of the transport belt 65, 75 is plotted. As the interrupted line 155 shows, a transporting speed V can be controlled in proportion to the position of the controller actuator 151 during travel operation F of the person-transporting installation. Other variants are also possible, however. The acceleration profile 159 shown with a solid line shows a nonlinear transformation for an increase in the transporting speed V, and the deceleration curve 157 shown by the dot-dashed line shows a nonlinear transformation for a reduction in the transporting speed V, in order, for example, to minimize the risk of the users falling.

As is also shown in FIG. 3A, the speed controller 23 has a reset mechanism 152 for the controller actuator 151. The reset mechanism 152 has the task of bringing the controller actuator 151 into a position reflecting the current travel speed 81 of the person-transporting installation 61, 71 that is connected to the speed controller 23. The resetting takes place immediately after the establishment of a signal connection between the controller 63, 73 and the speed controller 23, or when the control module 31 changes the signal connection to another person-transporting installation 61, 71, 81.

FIG. 4 shows a diagram with a predetermined acceleration limit value a_{Amax} and a predetermined deceleration limit value a_{Dmax} when using the speed controller 23. The time t is plotted on the abscissa of the diagram, and the acceleration as or the deceleration ap is plotted on the ordinate. The dash-dotted line shows an acceleration and deceleration curve 161 as could be caused by the monitoring personnel without any limits. In order to limit the strength of the accelerations as and decelerations a_{D}, the reduction in the transporting speed V follows a stored deceleration profile D_{S}, or the increase in the transporting speed V follows a stored acceleration profile A_{S}, as can be seen from the arcuate sections of the acceleration and deceleration curve 163 shown with a drawn line. The predefined acceleration limit value a_{Amax} and predefined deceleration limit value a_{Dmax} define that manual control can take place up to these values, but that these values cannot be exceeded. In other words, the acceleration limit a_{Amax} and deceleration limit a_{Dmax} prevent an excessively abrupt deceleration a_{D} or an excessively large acceleration a_{A} from occurring in certain acceleration or deceleration phases of the transport belt, such as when starting up or immediately before coming to a complete stop, due to an excessively fast adjustment of the controller actuator 151.

Although escalators are shown in FIGS. 1 and 2, it is obvious that the monitoring system can also be used for moving walkways. In addition, other time sequences are possible—particularly for the signal transmissions between the modules 11, 21, 31, 43, . . . , 46+2n of the monitoring system 1 described above.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above embodiments may also be used in combination with other features or steps of other embodiments described above. Reference signs in the claims should not be considered to be limiting.

1-15. (canceled)

16. A method for monitoring a travel operation of a person-transporting installation configured as an escalator or moving walkway with a monitoring system, wherein the monitoring system comprises a hazard analysis module, an interaction module, a control module, and at least one motion-sensing module, wherein the at least one motion-sensing module corresponds to an associated person-transporting installation and is configured to capture electronically processable motion sequence images of situations that occur on the associated person-transporting installation, the method comprising:
transmitting the electronically processable motion sequence images in real time to the hazard analysis module;
examining the electronically processable motion sequence images in the hazard analysis module with analysis algorithms for critical situations, and, as soon as a critical situation is detected, sending a warning signal to the interaction module, wherein the warning signal comprises at least one identification number of the at least one motion-sensing module in an electronically processable motion sequence image of which the critical situation was detected;
displaying a display, based upon the warning signal, of the electronically processable motion sequence image correlating with the at least one identification number on a screen of the interaction module;
sending, from the interaction module to the control module, a person-transporting installation identification number of the person-transporting installation which is associated with the at least one identification number of the at least one motion-sensing module; and
establishing temporarily with the control module, based upon the person-transporting installation identification number, a signal connection between a speed controller of the interaction module configured to be actuated manually and a controller of the person-transporting installation corresponding to the person-transporting installation identification number.

17. The method of claim 16, wherein, during the travel operation of the person-transporting installation, a transporting speed is controlled proportionally to a position of the speed controller.

18. The method of claim 17, wherein a reduction in the transporting speed down to a predetermined deceleration limit value is controlled manually.

19. The method of claim 17, wherein an increase in the transporting speed up to a predetermined acceleration limit value is controlled manually.

20. The method of claim 16, wherein a reduction in a transporting speed follows a stored deceleration profile, and, as a result, a direct implementation of a change in a position of the speed controller is overridden.

21. The method of claim 16, wherein an increase in a transporting speed follows a stored acceleration profile, and, as a result, a direct implementation of a change in a position of the speed controller is overridden.

22. The method of claim 16, wherein the monitoring system further comprises an emergency stop triggering device configured to be actuated manually, wherein the method further comprises:
establishing, based on the person-transporting installation identification number received, a connection by the control module between the emergency stop triggering device and the controller of the associated person-transporting installation; and
stopping immediately, when the emergency stop triggering device is actuated manually, the travel operation of the person-transporting installation connected to the emergency stop triggering device.

23. The method of claim 16, wherein a set of possible critical situations is stored in the hazard analysis module, wherein the set of possible critical situations comprises various atypical motion scenarios with which motion sequences extracted from the electronically processable motion sequence images are compared, and, in an event of sufficient correspondence between an extracted motion sequence and an atypical motion scenario, an existence of critical situations is assumed, and the warning signal is sent to the interaction module.

24. The method of claim 23, wherein the various atypical motion scenarios in the set of possible critical situations are assigned a weighting in the sense of a ranking.

25. The method of claim 24, wherein the travel operation is influenced based upon the weighting, such that the control module enables only a connection between an emergency stop triggering device to be actuated manually and the controller of the person-transporting installation corresponding to the person-transporting installation identification number for actuation when the weighting is a very high weighting.

26. The method of claim 24, wherein the travel operation is influenced based upon the weighting, such that the control module enables only a connection between the speed controller to be actuated manually and the controller of the person-transporting installation corresponding to the person-transporting installation identification number for actuation when the weighting is a medium weighting.

27. The method of claim 24, wherein the travel operation is influenced based upon the weighting, such that the control module does not enable a connection between an emergency stop triggering device to be actuated manually and the controller of the person-transporting installation corresponding to the person-transporting installation identification number for actuation nor a connection between the speed controller to be actuated manually and the controller of the person-transporting installation corresponding to the person-transporting installation identification number for actuation when the weighting is a low weighting.

28. The method of claim 16, wherein the at least one motion-sensing module is configured to capture motion sequence images of at least two different person-transporting installations, wherein each of the at least one motion-sensing module comprises an identification number and is configured to provide its motion sequence image with its identification number to the hazard analysis module, wherein the hazard analysis module is configured to provide the warning signal with the identification number of the at least one motion-sensing module that provided the electronically processable motion sequence image, and, in the interaction module, the person-transporting installation identification numbers are unambiguously assigned to the identification numbers.

29. The method of claim 24, wherein the hazard analysis module is configured to send warning signals with the weighting to the interaction module in immediate succession when a plurality of critical situation are recognized simultaneously, wherein the electronically processable motion sequence images are displayed successively on the screen based upon their weighting.

30. The method of claim 16 further comprising generating by the interaction module, based upon the warning signal on the screen, a cancellation input field, and, through a manual tapping of the cancellation input field, the interaction module is configured to cancel the warning signal and to withdraw the display of the electronically processable motion sequence image.

31. The method of claim 16 further comprising outputting by the interaction module or the control module, when the warning signal is present, an acoustic and/or optical warning to users of the person-transporting installation via an output module, and wherein the output module is arranged in a region of the person-transporting installation with which the warning signal is associated.

32. The method of claim 17, wherein a set of possible critical situations is stored in the hazard analysis module, wherein the set of possible critical situations comprises various atypical motion scenarios with which motion sequences extracted from the electronically processable motion sequence images are compared, and, an event of sufficient correspondence between an extracted motion sequence and an atypical motion scenario, an existence of critical situations is assumed, and the warning signal is sent to the interaction module.

33. The method of claim 17, wherein the at least one motion-sensing module is configured to capture motion sequence images of at least two different person-transporting installations, wherein each of the at least one motion-sensing module comprises an identification number and is configured to provide its motion sequence image with its identification number to the hazard analysis module, wherein the hazard analysis module is configured to provide the warning signal with the identification number of the at least one motion-sensing module that provided the electronically processable motion sequence image, and, in the interaction module, the person-transporting installation identification numbers are unambiguously assigned to the identification numbers.

34. A monitoring system for carrying out the method of claim 16 in a person-transporting installation configured as an escalator or moving walkway, which monitoring system comprises at least one hazard analysis module, an interaction module, a control module, at least one motion-sensing module, and a speed controller configured to be actuated manually, which are connected to one another via a data network.

35. The monitoring system of claim 34, wherein a controller actuator of the speed controller has a reset mechanism, which reset mechanism, immediately after setting up a connection between the controller and the speed controller or when a connection to another person-transporting installation is changed by the control module, brings the controller actuator into a position which represents a current travel speed of the person-transporting installation connected to the speed controller.
